(19) United States
(12) Patent Application Publication
(10) Pub. No.: US 2003/0187089 A1
(43) Pub. Date: Oct. 2, 2003

(54) Perma-ink insert mold decoration system

(75) Inventors: Clydene G. Hohenrieder, Alamo, CA (US); Joseph C. Hohenrieder, Alamo, CA (US); Jerry G. Vandentop, Lodi, CA (US); Bobbie S. Sabio, Stockton, CA (US)

Correspondence Address: Robert E. Krebs, THELEN REID & PRIEST, LLP, P.O. BOX 640640, SAN JOSE, CA, 95164-0640, US

(73) Assignee: Lustre-Cal, a California Corporation

(21) Appl. No.: 10/357,874

(22) Filed: Feb. 3, 2003

Related U.S. Application Data
(60) Provisional application No. 60/354,891, filed on Feb. 4, 2002.

(51) Int. Cl. C08G 2/00

(52) U.S. Cl. 522/173

(57) ABSTRACT

The present invention provides for a heat resistant UV-curable ink composition comprising at least one monomer, a UV thinner, and a flow agent.

### CROSS-REFERENCE TO RELATED APPLICATION

This application claims priority to provisional U.S. Application Serial No. 60/354,891, filed Feb. 4, 2002, which is incorporated herein by reference in its entirety.

### FIELD OF THE INVENTION

This invention relates to UV-curable ink formulations for use in surface printing, forming and molding decorative films that can then be used in injection molding processes, such that the films may become an integral part of a molded product.

### BACKGROUND OF THE INVENTION

Injection molded parts may be decorated after the part is made (for example applique, or laser etching). Because these types of decorations peal or wear off, decorations that are an integral part of the material are preferred. In-mold decorating processes are used to create the decorations during the molding process. There are primarily three methods used to prepare in-mold decorations.

One in-mold method is the “multi-shot, multi-color molding” where several differently colored polymers are combined into a single molded part, using a highly complex injection tool. The main body of the part is molded, creating the first color. The tool is then automatically reconfigured to allow a second, (and possibly a third and fourth) colored polymer to be injected into specific recesses to create legends or other decorations. This method is well suited to high-volume production of pieces with backlit effects. The disadvantages are the high cost of tooling and the associated costs of responding to design changes.

Second are “in-mold foils”, essentially a transfer process. Polyester-based films (foils) are generally gravure printed by the supplier. In the automotive industry, these foils are especially useful for simulating chrome plating or matching a paint color. The image is transferred to the molding during the molding process.

The third method involves the use of “Printed transfers”, wherein a release-coated carrier film is printed with a pattern layer; a transfer adhesive is coated or printed over that, and the image is transferred to the finished part by running the printed film into the injection mold. A hard coating can also be applied to the carrier film before the pattern is printed. This enhances the durability of the print and can be important, as the printed image will be on the exposed surface of the part and is vulnerable to wear. This method typically does not produce an image that possesses sufficient density for backlighting.

There is a real opportunity for screen-printing in the decoration of 3-D parts. In its simplest form, this involves a small, flat label (or a formed label) that is positioned in an injection mold and bonded in place during the molding process. In-mold decorating (IMD) may also involve printing on polycarbonate, polyester, or a similar film. After the film is printed, it is placed into a mold. Next, molten plastic resin is injected into the mold behind the film. If the film is not formed first, then the material softens and takes on the shape of the mold. The film may also be preformed after printing to precisely fit the mold. The resin and film bond during the molding process, creating a single three-dimensional part with nearly indestructible graphics. The process is used to create a variety of products, including automotive components, consumer electronics, and appliance components.

Some of the advantages of insert IMD over other methods are that 1) insert IMD is capable of the deepest formed applications, 2) It can be used to apply images in close register to the mold profile (within ±0.2-mm positional tolerance), 3) selective second-surface printing can be used to apply gloss or texture variations, and 4) the images can be applied as first-surface prints, where the printing is encapsulated within the finished part, providing complete protection against wear.

Screen-printing is the preferred imaging method for insert IMD. One of the key reasons for this is the adaptability of the screen-printing process, which makes short-run customization possible. The most important advantage that screen printing offers is the opacity of the inks. This allows for the production of stunning, pinhole-free backlit effects, similar to those seen in automotive dial applications.

UV-curable inks are the first choice of nameplate, overlay, and membrane switch printers because there is less exposure to volatile organic solvents, which may be harmful to employees and the environment. In addition these inks have excellent color value, do not dry on the screens, cure very rapidly and overall produce far less waste than traditional solvent based inks. They are however, not ideally suited to use in IMD primarily due to their inability to withstand the high temperatures associated with the injection molding procedures.

Currently, most in-mold decorating is done with solvent-based inks, but recent developments in formable, temperature-resistant UV inks are changing this. However, the use of UV-curable inks for in-mold applications is still in its infancy, and the process requires skill in both graphic design and printing. Graphics must be designed to achieve the desired appearance when they distort during the molding process, and care must be taken to ensure that the depth of draw doesn't exceed the ink's capabilities.

For these reasons a need exists for new ink formulations and films with UV-curable inks for use with in-mold decorating processes.

### SUMMARY OF THE INVENTION

A heat resistant UV-curable ink composition comprising at least one monomer, a UV thinner, and a flow agent. The present invention involves films that contain multicolor UV-curable inks and are used in an insert-mold decorating process, wherein said film comprises a substrate printed using the novel UV-curable ink system, and a heat-resistant barrier for the UV-curable ink, coated on said substrate. The resulting film will not crack, run or change color during the elevated temperature exposure that occurs in the injection molding process.

### DETAILED DESCRIPTION OF THE INVENTION

Embodiments of the present invention are described herein in the context of perma-ink insert mold decoration system. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Definitions

The following terms as used herein have the meanings indicated.

The term “in-mold decorating” refers to any process that which applies text, patterns or graphics to a molded part, as part of the molding process. A more complex version of the technology involves second surface printing, forming, and molding of a decorated film that becomes an integral part of the final molded product. The preprinting/decorating of the film is done prior to the forming and molding process. The molding process consists of injecting a molten resin into a mold cavity, which contains the pre-printed or decorated film. Once the molten resin contacts the film, the two materials fuse, fully encapsulating and protecting the inks, and forming the insert-mold decorated product. The technology eliminates the need for post-molding steps such as pad printing.

The term “molding process” refers to a process by which a plastic part is formed from polymeric starting material.

The terms “UV-Ink” or “UV-curable ink” refer to inks that are used in printing procedures, especially screen printing, and that is cured using UV irradiation.

The term “solvent based ink” refers to inks that are used in printing procedures, especially screen printing, that is cured by allowing solvents to evaporate from the ink formulation.

Formulations and methods of the present invention surprisingly provide for encapsulation of multi-color UV curable inks that will withstand the high temperatures of molten resin during the injection molding process of up to 580° F. This new ink system will not crack, run or change color during elevated temperature exposure while maintaining adequate bonding to both the resin and the substrate ensuring product integrity.

Preferred substrates are polycarbonate or polyester films. The substrate is predecorated using a second surface printing method, on a flat bed silk screen-printing machine.

The UV-curable ink is a composition formulated using acrylated oligomers, N-vinly-2-Pyrrolidone or acrylated monomers such as urethane actylate, isobornyl acrylate, acrylated amine, and photoinitiators. The UV curable ink system may comprise of three critical additives: 3% by volume of UV thinner, 1% by volume of flow agent, and 2% by volume of hardener. Colorants may be added to the composition to formulate the multi-color UV curable inks. The inks are used with screens with mesh counts between 280 and 355 threads per inch.

The preferred UV thinner is 09-070, the preferred flow agent is Flow Bubble Control-065 and the preferred hardener is 800 initiator, all of which are available from Nor-Cote International located in Crawfordsville, Ind.

Each color laydown is cured with a UV curing unit with lamp output of 300 watts per inch and a conveyor belt speed of 50 feet per minute. Increased conveyor speeds are possible with 600 watt per inch lamps.

The final coating is a water-based screen printable selective heat resistant texturing varnish that provides a heat-resistant barrier for the UV-curable ink. The preferred varnish is Aquatex SC sealcoat sold by Autotype Americas Inc. located in Schaumburg, Ill. If needed, water may be mixed with the varnish to change the viscosity of formulation. The heat-resistant coating is printed with a 196-mesh screen. The coated product is forced-air cured at a temperature of 300° F. for 3 minutes. The squeegee durometer is 75 to 80 shore A. After final coating the product is air dried at room temperature for 24 hours.

Forming methods that involve Thermo or Vacuum forming or high pneumatic pressure methods are preferred. Tool contact forming methods, although possible, are not preferred due to the possible abrasion of the ink. The parts are die cut to the preferred shape with matched die cutting tooling or laser cut to the desired configuration. The single die cut part is injection molded against the printed surface. The print film will withstand molten resin temperature of up to 580° F.

### EXAMPLE 1

The following is an example of how to re-formulate UV IMD ink. If the ink is used as text on a product, an additive may be made by adding 1.5% by volume of 074 adhesion promoter, 1% by volume of Flow Bubble Control-065, and 2% by volume of 09-070 UV thinner.

The UV IMD ink may comprise 21%-42% by weight of urethane acrylate, 9%-18% by weight of isobornyl acrylate, 2% by weight of acrylated amine, and 3%-8% by weight of photoinitiators. The additive is then added to the UV IMD ink and mixed thoroughly.

### EXAMPLE 2

The following is an example of how to re-formulate UV IMD ink. If the UV IMD ink is used as background color, an additive may be made by adding 3% by volume of 076 Flexibilizing Agent, 1% by volume of Flow Bubble Control-065, 3% by volume of 09-070 UV thinner, and 2% by volume of 800 initiator.

The UV IMD ink may comprise 21%-42% by weight of urethane acrylate, 9%-18% by weight of isobornyl acrylate, 2% by weight of acrylated amine, and 3%-8% by weight of photoinitiators. The additive is then added to the UV IMD ink and mixed thoroughly.

### EXAMPLE 3

The following is an example of how the re-formulated UV IMD ink may be printed onto a substrate. A polycarbonate film may be cleaned with isopropyl alcohol to eliminate any chemical residue and contaminants. Anti-static spray may then be sprayed around the substrate, at least 6 to 8 inches from the substrate, to prevent fuzzy prints and static shock.

The UV ink mixture may then be printed onto the polycarbonate film on a second side. The UV ink mixture of Example 1 or Example 2 may be used. However, the ink mixture should be made at least 10 minutes prior to use, but should not be used after 3 hours. The ink mixture may be printed onto the film using a screen having 355 threads per inch and an 80 durometer polyurethane squeegee having smooth and slightly rounded edges.

The film is then post-cured by sending the film face-up through a UV dryer. Each film may be racked individually in the UV dryer to avoid moisture and helps the ink to continue to cure. The UV dryer may consist of two UV lamps—a front UV lamp may be set at 300 watts per inch and the back UV lamp may be set at 200 watts per inch. The conveyer belt speed of the UV dryer may be set at 50 feet per minute.

Twenty-four hours after the screen printing is complete, Aquatex SC sealcoat may be placed over the ink mixture and film. The sealcoat may be mixed with 4% by volume of water. The sealcoat mixture may be printed over the ink mixture and film using a screen having 196 threads per inch and an 80 durometer polyurethane squeegee having smooth rounded edges. The film may then be sent through a jet dryer set at 300° F. with a conveyer belt speed of 50 feet per minute for 10 minutes. Each film may be racked individually for 24 hours to thoroughly air dry at room temperature. After 24 hours, the film may then be ready for forming and injection molding.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

We claim:

1. A heat resistant UV-curable ink composition comprising at least one monomer, a UV thinner, and a flow agent.

2. The ink of claim 1 wherein said ink composition comprises 3% by volume of said UV thinner.

3. The ink of claim 1 wherein said ink composition comprises 1% by volume of said flow agent.

4. The ink of claim 1 wherein said ink composition further comprises 2% by volume of a hardener.

5. The ink of claim 1 wherein said at least one monomer is selected from the group consisting of acrylated oligomers, N-vinyl-2-Pyrrolidone, and acrylated monomers.

6. The ink of claim 1 wherein said at least one monomer is selected from the group consisting of urethane actylate, isobornyl acrylate, acrylated amine and photoinitiators.

7. The ink of claim 1 wherein said ink withstands temperatures up to 580° F.

8. A film for use in insert-mold decorating, comprising:
a first surface and a second surface;
at least one UV-curable ink composition coupled to said second surface; and
a heat-resistant barrier coupled to said at least one UV-curable ink composition,
wherein said second surface is to receive a molding medium.

9. The film of claim 8 wherein said at least one UV-curable ink composition and said heat-resistant barrier withstands temperatures up to 580° F.

10. The film of claim 8 wherein said UV-curable ink composition comprises at least one monomer, a UV thinner, and a flow agent.

11. The film of claim 10 wherein said ink composition comprises 3% by volume of said UV thinner.

12. The film of claim 10 wherein said ink composition comprises 1% by volume of said flow agent.

13. The film of claim 10 wherein said ink composition further comprises 2% by volume of a hardener.

14. The ink of claim 10 wherein said at least one monomer is selected from the group consisting of acrylated oligomers, N-vinyl-2-Pyrrolidone, and acrylated monomers.

15. The ink of claim 10 wherein said at least one monomer is selected from the group consisting of urethane actylate, isobornyl acrylate, acrylated amine and photoinitiators.

16. The film of claim 8 wherein said heat-resistance barrier is a heat resistant varnish.

17. The film of claim 16 wherein said heat resistant varnish is a water-based screen printable selective texturing varnish.

18. The film of claim 8 wherein said film is made of ploycarbonate.

19. The film of claim 8 wherein said film is made of polyester.

20. A method for making a UV-curable ink composition comprising:
combining at least one monomer; and
adding a UV thinner, and a flow agent.

21. The method of claim 20 wherein said ink composition comprises 3% by volume of said UV thinner.

22. The method of claim 20 wherein said ink composition comprises 1% by volume of said flow agent.

23. The method of claim 20 further comprising adding 2% by volume of a hardener.

24. The ink of claim 20 wherein said at least one monomer is selected from the group consisting of acrylated oligomers, N-vinyl-2-Pyrrolidone, and acrylated monomers.

25. The ink of claim 20 wherein said at least one monomer is selected from the group consisting of urethane actylate, isobornyl acrylate, acrylated amine and photoinitiators.

26. The method of claim 20 wherein said ink withstands temperatures up to 580° F.

27. A method for making a film for use in insert-mold decorating, comprising:
applying at least one UV-curable ink composition on a second surface of said film;
curing said at least one UV-curable ink;
coating said at least one UV-curable ink with a heat-resistance barrier.

28. The method of claim 27 wherein said UV-curable ink further comprises at least one monomer, a UV thinner, and a flow agent.

29. The method of claim 28 wherein said UV-curable ink comprises 3% by volume of said UV thinner.

30. The method of claim 28 wherein said UV-curable ink comprises 1% by volume of said flow agent.

31. The method of claim 28 wherein said UV-curable ink further comprises 2% by volume of a hardener.

32. The ink of claim 28 wherein said at least one monomer is selected from the group consisting of acrylated oligomers, N-vinyl-2-Pyrrolidone, and acrylated monomers.

33. The ink of claim 28 wherein said at least one monomer is selected from the group consisting of urethane actylate, isobornyl acrylate, acrylated amine and photoinitiators.

34. The method of claim 27 wherein said film is made of polycarbonate.

35. The method of claim 27 wherein said film is made of polyester.

36. The method of claim 27 wherein said applying further comprises predecorating said second surface of said film with a second surface printing method on a flat bed silk screen-printing machine.

37. The method of claim 27 wherein said applying uses a screen having a mesh count between 280 and 355 threads per inch.

38. The method of claim 27 wherein said curing further comprises a UV curing unit having a lamp output between 200-600 watts per inch and a conveyor belt speed between 30-70 feet per minute.

39. The method of claim 27 wherein said heat-resistance barrier is a texturing varnish.

40. The method of claim 39 wherein said texturing varnish is a water-based screen printable selective texturing varnish.

41. The method of claim 27 wherein said coating further comprises printing said heat-resistance barrier with a 196-mesh screen.

42. The method of claim 27 wherein said coating is between 200-500° F. for between 1-3 minutes.

43. The method of claim 27 further comprising air-drying said substrate at room temperature for between 15-35 hours.

44. The method of claim 27 wherein said at least one UV-curable ink withstands temperatures up to 580° F.
